(19) United States
(12) Patent Application Publication
(10) Pub. No.: US 2016/0247036 A1
(43) Pub. Date: Aug. 25, 2016

(54) STRUCTURAL DATA DISPLAY

(71) Applicant: UBIMAKE GMBH, Berlin (DE)

(72) Inventors: Stefan Boschert, Neubiberg (DE); Dirk Hartmann, Assling (DE); Claudia-Camilla Malcher, Muechen (DE); Philipp Emanuel Stelzig, Kammlach (DE)

(21) Appl. No.: 15/026,029

(22) PCT Filed: Sep. 26, 2014
(86) PCT No.: PCT/EP2014/070660

§ 371 Date: Mar. 30, 2016

(30) Foreign Application Priority Data
Sep. 30, 2013 (DE) 10 2013 219 736.5

(51) Int. Cl. G06K 9/22; G06F 17/50

(52) U.S. Cl. CPC G06K 9/224; G06F 17/50

(57) ABSTRACT

A system includes a user-controlled tool for providing a strip of a fast binding compound in order to generate a three-dimensional freehand shape from the strip; an optical sampling device for sampling the strip; a processing device for detecting basic geometric figures in sections of the sampled strip; and a conversion device for providing geometric structural data for the freehand shape based on the detected figures.

### BACKGROUND

1. Field of the Invention

The present invention relates to the generation of structural data for a CAD System. The invention relates in particular to converting a freehand shape to structural data for the CAD system.

2. Description of the Related Art

Usually a CAD system is used for professionally designing an article. The CAD system permits parametric design, that is, it permits relationships between elements of the article to be established so that a modification to one element can automatically or semi-automatically effect a modification to a different element. For instance, a functional component, such as a shaft, may be dimensioned at the same time that an adjacent bearing or shaft seal is dimensioned. Parameterizability of such articles is frequently indispensable for combining a plurality of them to create a higher-level structure. For instance, different work groups may work on different subsystems of a complex article, such as a motor vehicle, and exchange information by means of their structural data.

Work on a CAD system is normally complex and can only be navigated by people with special training. The concept of the CAD system is generally not accessible to a creative process. For instance, a person who is concerned with the external configuration of the object, like a designer or fluid dynamicist, may have problems converting his ideas about the shape of an object to structural data that can be processed by means of a CAD systems. Therefore, working jointly with a design engineer who operates the CAD system and handles structural aspects of the article may be difficult.

To address this problem, it is customary to produce a full three-dimensional model, for instance from clay, and then to optically scan it to provide the structural data for the CAD system. However, this requires someone experienced to create the model, and also requires the processing of a large number of sampled points on the surface of the model. In addition, frequently it is not possible to automatically subcategorize the sampled points into individual elements of the article.

It is therefore the object of the present invention to provide a method and a computer program product that permit simplified conversion of a three-dimensional freehand shape to structural data. The invention attains these objects by means of the subject-matters in the independent claims. Subordinate claims provide preferred embodiments.

### SUMMARY

An inventive system includes a user-controlled tool for providing a strip of a fast binding compound in order to produce a three-dimensional freehand shape from the strip, an optical sampling device for sampling the strip, a processing device for detecting basic geometric figures in sections of the sampled strip, and a conversion device for providing geometric structural data for the freehand shape on the basis of the detected figures.

A pen-like device that is known under the name “3Doodler” may be used as the tool, for instance. In the manner of a hot-glue gun, a strip of heated plastic is output and cools rapidly, thereby hardening, after leaving the tool. Proceeding from a work surface, the strip may be shaped as desired in space, so that three-dimensional structures may be represented. Such a tool can enable even an inexperienced person to express his ideas in a three-dimensional freehand shape. The person is not limited to processing two-dimensional views of the freehand shape, as is normally necessary on a computer system with a screen. In addition, the freehand shape may be perceived haptically, so that the user can express himself even more effectively. A learning process or familiarization period for such a tool may be brief or omitted entirely. The tool is therefore particularly suitable for converting the ideas of a creative person, or of a person who has particularly acute spatial comprehension but limited means of expression, into a three-dimensional freehand shape. In addition to the described tool, other related tools may be used for producing a three-dimensional freehand shape.

By sampling the strip, it is possible to prevent the production of large point clouds that generally occur when three-dimensional surfaces are scanned. Since the tool provides a strip, the three-dimensional freehand shape is normally embodied as a lattice structure that can be sampled more easily. In particular, a data volume that occurs due to the sampling may be relatively small. Because of this, processing resources can be saved and the processing can proceed more rapidly.

Geometric figures into which sections of the sampled strip are converted may describe “prettier” shapes than the user may be able to express by means of the tool. For instance, a perfectly straight line or a perfect circular arc may be extracted from the sampled information of the lattice structure. The original intention of the user may thus be detected and realized in an improved manner. The geometric figures may be converted to structural data in a simple and efficient manner, so that the structural data can express, in a good approximation, that which the user was originally attempting to express. Thus overall the product of a creative process of the user can be rendered accessible to technical processing, for instance using a CAD system.

In a first variant, the sampling device includes an optical positioning system for tracking the tool in space, while the user generates the freehand shape. Due to this, simultaneous to the work of the user, a more virtual presentation of the freehand shape may be produced that may later be further processed, so that there can be an immediate response to the user. For instance, the tool may be tracked by means of stereo cameras, while the user generates the freehand shape. In another embodiment, the tool may also be illuminated by means of structured light and only one camera for sampling reflections of the structured light from the tool is provided. The structured light may include, for instance, a pseudo-random point pattern. This approach may be the same as that of Microsoft's Kinect. In yet another embodiment, special active or passive markers may be provided on the tool in order to determine the position of the tool in space. This approach is known from the field of positioning surgical devices.

In another variant, the sampling device includes a camera for optically sampling all strips of the finished freehand shape. The sampling thus does not occur until the user has already produced the freehand shape. A conventional 3D scanner may be used for this, for instance. This variant may be especially cost-effective and flexible to realize.

One inventive method for converting a three-dimensional freehand shape into structural data for the freehand shape includes steps of sampling, by means of an optical sampling device, a strip of fast binding compound that, user controlled, forms the freehand shape; detecting basic geometric figures in sections of the sampled strip; and providing geometric structural data for the freehand shape based on the detected figures.

The method may be used for advantageous generation of CAD structural data on the basis of the three-dimensional freehand shape of the user. Thus it is possible for an inexperienced person to input, in a simple, robust, and non-complex manner, structural data that can be further processed technically.

In one variant, the strip is sampled optically, while the user generates the freehand shape. In this way, the method may also be operated interactively so that the user may intervene, for instance, if a part of the strip is detected incorrectly.

In another variant, all of the strips of the freehand shape are sampled optically after the freehand shape has been completed. The sampling may in particular occur in one or a plurality of passes simultaneously for all strips. If there are deficiencies or errors, it is not a complex process to repeat the sampling. In addition, impairments to the user while the article is being generated, for instance due to the need for free sightlines for the optical sampling device, may not be necessary.

It is preferred when the basic geometric figures include one or a plurality of segments, circles, circular arcs, ellipses, ellipse segments, triangles, or rectangles. Based on these figures, a good approximation of any complex objects may be formed. In one variant, all of the basic geometric figures are in one plane. In this way the intention of the user may be better detected and the modelling of the article may be improved. In one particularly preferred embodiment, first two-dimensional geometric figures are detected and then one or a plurality of three-dimensional figure are detected or formed based on detected two-dimensional figures. Using this step-wise detection, inaccuracies such as for instance an incompletely closed line may be better interpreted or corrected before a more complex three-dimensional body is detected. This can improve the detection capacity of the system or method.

In another embodiment, detected three-dimensional figures are provided with surfaces. The surfaces may later be further processed, user-controlled or parametrically, for instance using extrusion, turning, or bridging. The provided structural data may thus be more realistically or more easily processable.

One inventive computer program product includes program code means for performing the described method when it runs on an execution device or is stored on a computer-readable medium.

The properties, features, and advantages of this invention that are described above, as well as the manner in which they are attained, will become more clear in the following description of the exemplary embodiments, which are explained in greater detail in connection with the drawings.

### BRIEF DESCRIPTION OF THE DRAWINGS

FIG. 1 depicts a system for providing geometric structural data.

FIG. 2 depicts an exemplary tool for generating a three-dimensional freehand shape.

FIG. 3 depicts another view of an exemplary tool for generating a three-dimensional freehand shape.

FIG. 4 depicts a flowchart for a method for converting a three-dimensional freehand shape to structural data for the freehand shape.

FIG. 5 depicts a first step in an exemplary detection of a geometric figure.

FIG. 6 depicts a second step in an exemplary detection of a geometric figure.

FIG. 7 depicts a third step in an exemplary detection of a geometric figure.

FIG. 8 depicts a fourth step in an exemplary detection of a geometric figure.

FIG. 9 depicts an edge detection using the example of a model of a motor vehicle.

FIG. 10 depicts edges of the model of a motor vehicle from FIG. 9.

### DETAILED DESCRIPTION

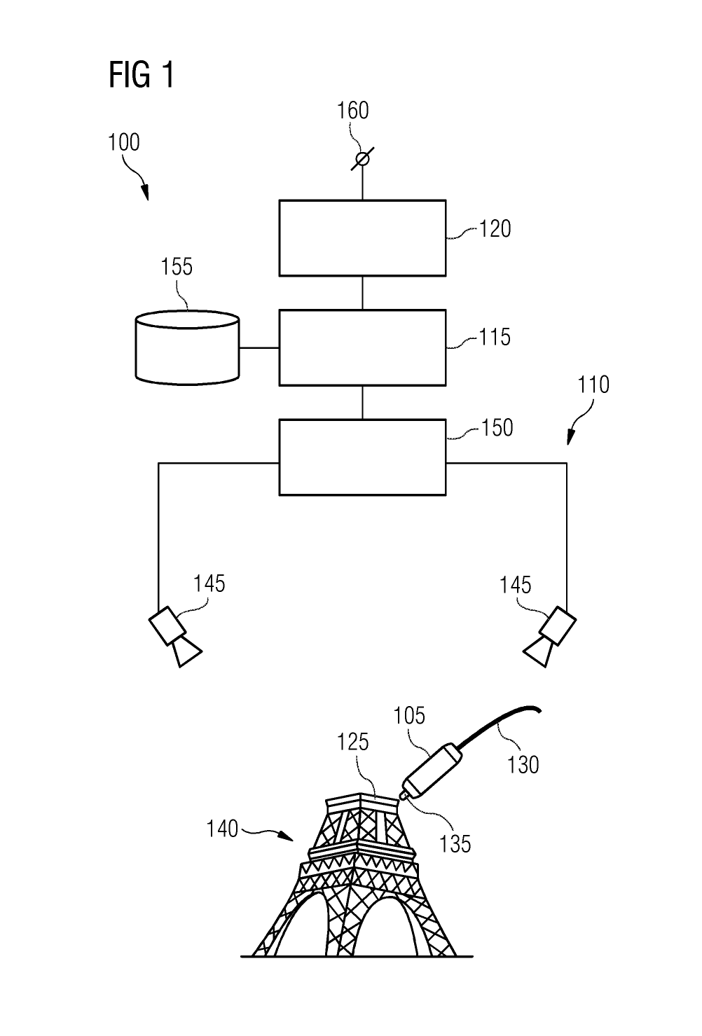

FIG. 1 depicts a system 100 for providing geometric structural data. The system includes a tool 105, an optical sampling device 110, a processing device 115, and a conversion device 120.

The tool 105 is set up to be controlled by a user in order to provide a strip 125 of fast binding compound. In the depicted exemplary embodiment, a plastic 130 may be heated by means of the tool 105 and output through a nozzle 135. The heated strip 125 is flexible when it exits the nozzle 135 and cools rapidly, hardening. The hardening may take, for instance, one second or a few seconds. After it has hardened, the strip 125 may have predetermined resilient properties or may be rigid. Controlled by a user, the strip 125 may form any shape. The user may thus produce a three-dimensional freehand shape 140, which in FIG. 1 is depicted as an example as the base of the Eiffel tower, by means of the tool 105. The freehand shape 140 is normally formed as a lattice structure that is composed of sections of the strip 125. The sections preferably each lie in one plane and connect two points. In one embodiment, all of the sections are straight lines; in another embodiment, curved sections are also possible.

The optical sampling device 110 is set up to sample the strip 125 that form the freehand shape 140. In a first embodiment, depicted in FIG. 1, the sampling device 110 includes an optical positioning system with two cameras 145 that function as a stereo camera. During the process of generating the freehand shape 140, the cameras 145 track the position of the tool 105 in space and a determination is made as to whether a strip 125 is being output. In one embodiment, the tool 105 may carry a passive marker in the form of a preferably optically easily resolvable reflex marking or an active marker in the form of a preferably easily detectable light source. In yet another embodiment, a light source for providing structured light may be provided in order to illuminate the output strip 125. The structured light may include for instance a point or line pattern with which an area is illuminated in which the tool 105 is being used in order to generate the freehand shape 140. The position of the tool 105 may then be sampled by the cameras 145 using reflections of the structured light on the tool 105. In one embodiment, it is also possible to provide only a single camera 145.

In another variant, the optical sampling device 145 is set up so that it does not sample the three-dimensional freehand shape 140 until the user has finished producing the freehand shape 140 by means of the tool 105. In addition, the freehand shape 140 may be optically sampled by means of the cameras 145 from one or a plurality of perspectives. In one embodiment, only one camera 145 is provided and the freehand shape 140 may be moved relative to the camera 145, for instance on a rotary table, in order to permit different perspectives for the camera 145. In principle the embodiments described in the foregoing may also be used with structured light in this variant.

In both variants, processing of the optically sampled data from the cameras 145 occurs by means of a control 150 that controls the cameras 145 and, where necessary, one of the described light sources or moving devices.

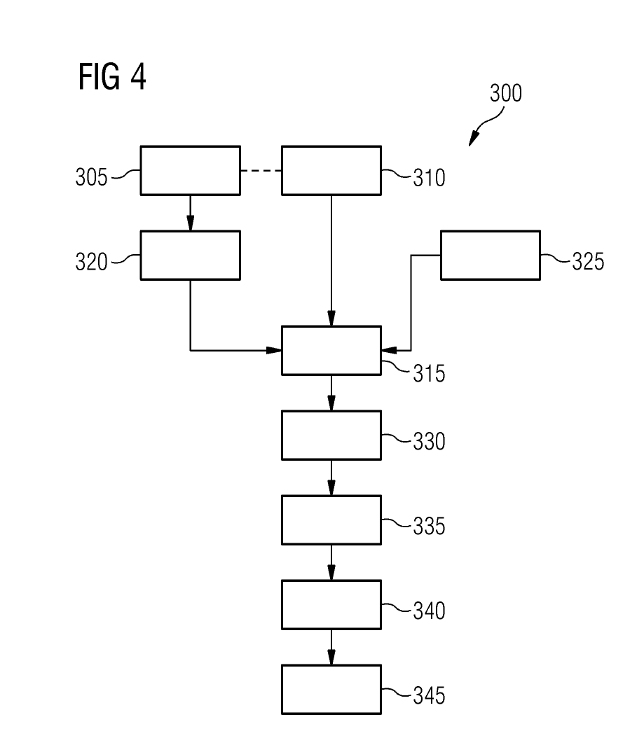

The processing device 115 preferably includes a programmable microcomputer and is set up to detect basic geometric figures in sections of the sampled strip 125 from the data provided by the control 150. In one embodiment, a memory 155 is provided that may be set up, for instance, for recording the data or information to be processed about the basic geometric figures. The manner in which the processing device 115 works is described in greater detail below, referring to FIG. 4.

The conversion device 120 is set up to provide structural data for the freehand shape 140 based on geometric figures detected by the processing device 115. For providing this, an interface 160 may be provided that may be realized conceptually as a software interface or physically as a hardware interface. In one embodiment, the conversion device 120 and the processing device 115 are embodied integrally.

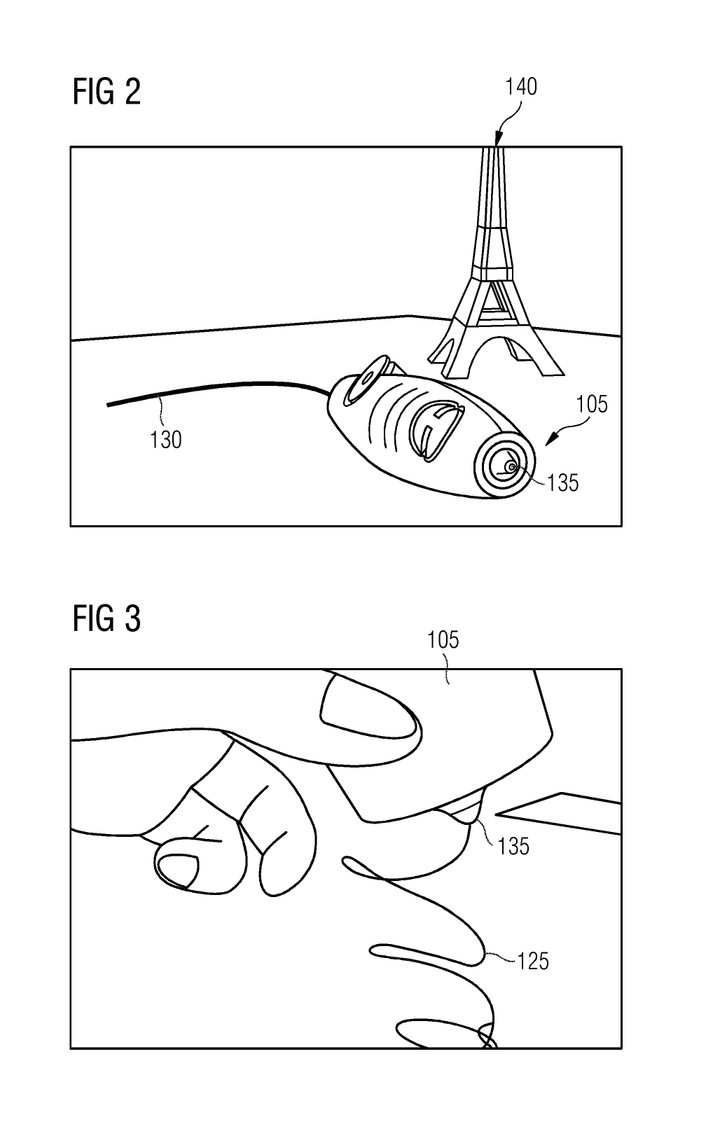

FIG. 2 depicts an exemplary tool 105 for generating the three-dimensional freehand shape 140 from FIG. 1. The depicted tool 105 is known as a 3Doodler, from the company of the same name. This embodiment of the tool 105 may be described as a hot glue gun for sketching 3D articles. For providing the strip 125, different plastics 130 may be provided that may differ, for instance, in terms of their diameter, color, or rigidity. Different nozzles 135 that have different widths or cross-sections may also be provided.

FIG. 3 depicts the tool 105 from FIG. 2 while the strip 125 is being output. One end of the strip 125 is connected to a work surface 205 and the strip 125 may be manipulated into a desired shape. The production of a spiral-shaped section of the strip 125 is depicted.

FIG. 4 depicts a flowchart for a method 300 for converting a three-dimensional freehand shape 140 to structural data for the freehand shape 140. The method 300 is especially set up for running on the processing device 115 and, where necessary, also on the conversion device 120. Parts of the method 300 may be retained in the memory 155.

In a first step 305, the freehand shape 140 is produced by a user by means of the tool 105. This step is not necessarily included in the method 300, but different variants of the method 300 require that this process be used. In a first variant, in one step 310 that runs concurrently with the step 305, the tool 105 is tracked by means of the optical sampling device 110. Movements in which no strip 125 is output from the tool 105 are preferably ignored. In one step 315 that may be performed by the control 150 or by the processing device 115, the produced freehand shape 140 is inferred.

In a second variant, the step 310 is not used and instead, after the step 305 has concluded, in a step 320 the finished freehand shape 140 is sampled by means of the optical sampling device 110. This process may also include other operations, for instance modification of an illumination or a perspective of a camera 145 onto the freehand shape 140 between several sampling passes. Then the step 315 is performed as described in the foregoing.

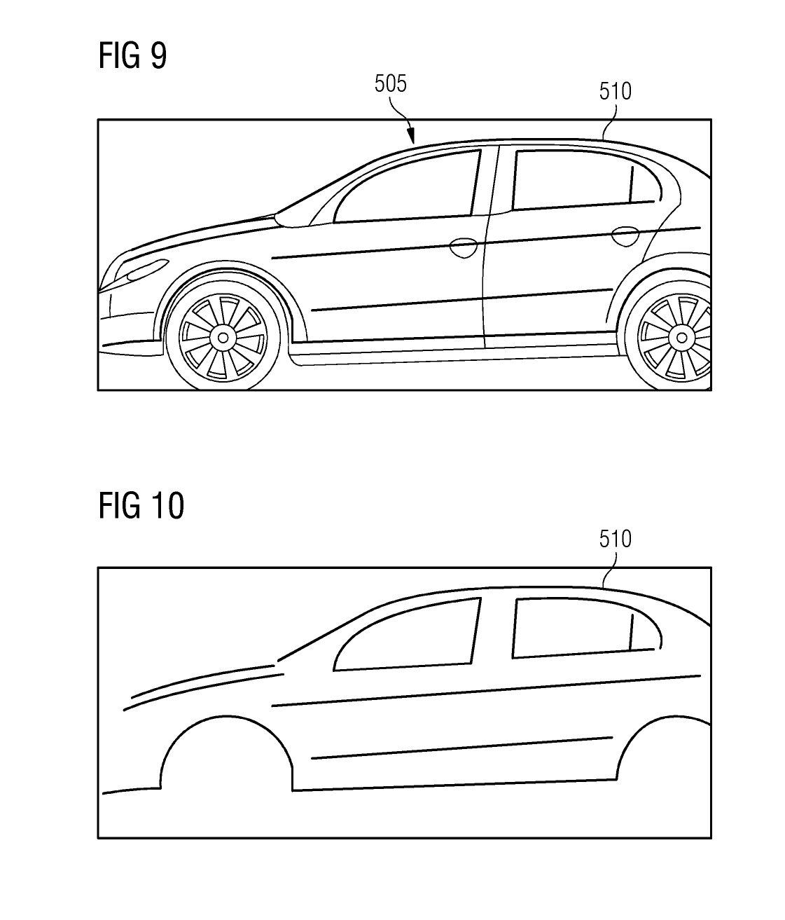

In yet another embodiment, the steps 305, 310 and 320 may also be replaced by one step 325 in which a three-dimensional volume model is sampled by means of the optical sampling device 110. The volume model is described in greater detail below, referencing FIGS. 9 and 10.

In step 315, first edges are detected based on the data provided by the optical sampling device 110. The edges normally correspond to sections of the strip 125 on the freehand shape 140. In one embodiment, only edges that extend in one plane in space are detected or approximated.

In one step 330, basic geometric figures are detected based on the edge information from step 315. The geometric figures preferably include at least some of a line, a circle, a circular arc, an ellipse, and ellipse segment, a triangle, and a rectangle. Additional geometric figures may also be provided. The aforesaid geometric figures are two-dimensional; in other embodiments, three-dimensional figures, such as a cuboid, a polyhedron, a cone, a cylinder, a sphere, or an equipotential ellipsoid may also be detected.

In one preferred embodiment, in the step 330 basic two-dimensional geometric figures are merely detected. Based on the detected two-dimensional figures, in one step 335 basic three-dimensional figures, that are composed of the two-dimensional figures already detected, may then be detected. Corrections may be made in each of the steps 330 and 335. For instance, a slightly jagged or curved edge may be converted to a straight edge. Edges whose ends do not meet precisely may be scaled or displaced such that they abut one another precisely at their end points.

In one optional step 340, surfaces may be added. Each surface covers a closed line made of sections of the strip 125. This step may also be performed integrally with the integration of the two-dimensional geometric figures into three-dimensional figures in the step 335. Surfaces of two-dimensional figures may be embodied as a section of a plane. Surfaces of three-dimensional figures may include simple or complex curves.

In one concluding step 345, structural data that represent the three-dimensional freehand shape 140 are prepared based on the known figures. The structural data are preferably output in a format that may be processed by a known CAD program. The detected figures may be parameterized and related to one another.

Ideally, it is possible to reproduce the freehand shape 140 based on the prepared structural data, for instance by means of a 3D printer. Adaptations to the structural data, for instance further merging of detected two-dimensional figures into three-dimensional figures or separation of three-dimensional figures into two-dimensional figures, processing of edges or surfaces, deleting or adding additional elements, and other work steps may be performed prior to step 345 or subsequently by means of the CAD program.

FIGS. 5 through 8 depict steps of one exemplary detection of a geometric figure as it may be performed, for instance, by means of the processing device 115 in FIG. 1 or by means of the method 300 in FIG. 3. FIG. 5 depicts a number of points 405 that may be sampled by the optical sampling device 110 during sampling of the freehand shape 140. It does not matter whether the freehand shape 140 in the first variant is sampled continuously while it is being generated or how it is scanned in the second variant after it has been generated.

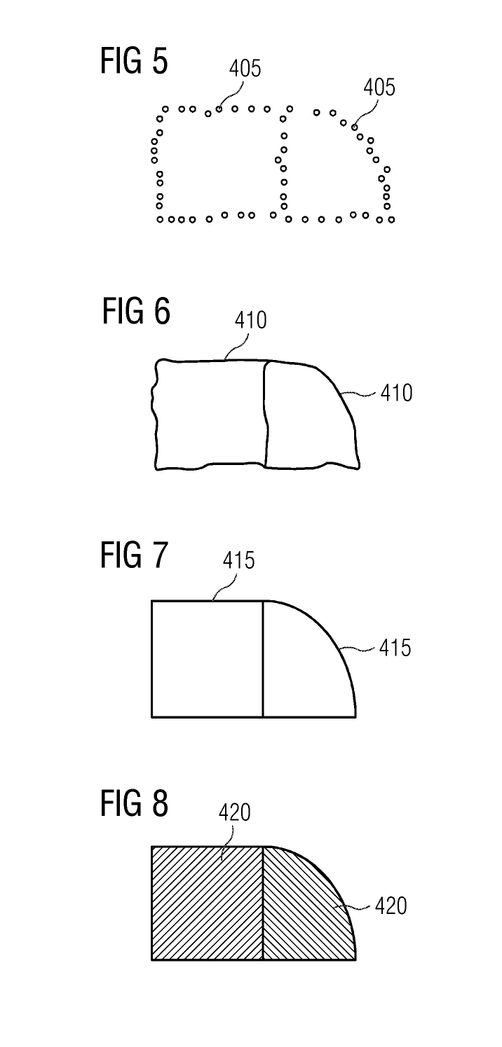

FIG. 6 depicts edges 410 that are each derived from subsets of the points 405. The edges 410 follow the points 405 relatively precisely and may include interpolations between the points 405, or even extrapolations, in order to permit the edges 410 to adjoin one another. In this case, processing of the edges 410 with respect to the position of individual points 405 has not yet occurred.

FIG. 7 depicts basic geometric figures 415 that were detected based on the edges 410. The figures 415 may include, for instance, a circular arc and a plurality of segments. In another embodiment, more complex two-dimensional figures that comprise a plurality of edges 410 may have been detected. For instance, in the example depicted in FIGS. 5 through 8, a square and a circular segment with boundary lines have been detected. The detected figures replace the individual points 405, wherein the data quantity for describing the figure may be reduced.

FIG. 8 depicts surfaces 420 that have been added to the geometric figures 415. The surfaces 420 may include sections of a plane or curved surfaces. In FIG. 7, if a spherical segment had been detected instead of a circular segment, the surface 420 depicted on the right could be, for instance, a segment of a spherical surface.

FIG. 9 depicts edge detection using the example of a model 505 of a motor vehicle. The model 505 is a volume model, that is, it has closed surfaces and material is also usually provided inside the surfaces. With the exception of the wheels of the motor vehicle, the depicted model 505 is typically made of clay. As described in the foregoing with reference to step 325 of FIG. 4, the model 505 is sampled optically by means of the optical sampling device 110 and the edges 510 are determined. FIG. 10 depicts the edges 510 of the model 505 from FIG. 9 without the rest of the model 505. Because of this, it is possible to avoid sampling a large number of points on the surface of the model 510 and complex conversions into representations of the surfaces. Instead, the determined edges 510 may be further processed, as the edges 410 in FIGS. 4B through 4D, or in steps 330 through 345 of the method 300 from FIG. 4.

Although the invention was illustrated and described in greater detail using the preferred exemplary embodiment, the invention is not limited by the disclosed examples and one skilled in the art may derive other variations therefrom, without leaving the protective scope of the invention.

1. A system (100), comprising:
a user-controlled tool (105) for providing a strip (125) of fast binding compound in order to generate a three-dimensional freehand shape (140) from the strip;
an optical sampling device (110) for sampling the strip (125);
a processing device (115) for detecting basic geometric figures (415) in sections of the sampled strip (125); and
a conversion device (120) for providing geometric structural data for the freehand shape (140) on the basis of the detected figures (415).

2. The system (100) of claim 1, wherein the sampling device (110) comprises an optical positioning system for tracking the tool (105) in space, while the user generates the freehand shape (140).

3. The system (100) of claim 1, wherein the sampling device (110) comprises a camera (145) for optically sampling all strips (125) of the finished freehand shape (140).

4. A method (300) for converting a three-dimensional freehand shape (140) to structural data for the freehand shape (140), wherein the method (300) comprises the following steps:
sampling (310, 320), by means of an optical sampling device (110), a strip (125) of fast binding compound that, user controlled, forms the freehand shape (140);
detecting (330, 335) basic geometric figures (415) in sections of the sampled strip (125); and,
providing (345) geometric structural data for the freehand shape (140) based on the detected figures (415).

5. The method (300) of claim 4, wherein the strip (125) is optically sampled (310), while the user generates the freehand shape (140).

6. The method (300) of claim 4, wherein all strips (125) of the freehand shape (140) are sampled optically (320) after the freehand shape (140) has been completed.

7. The method (300) of claim 4, wherein the basic geometric figures (415) include at least some of the following figures: segments, circles, circular arcs, ellipses, ellipse segments, triangles, rectangles.

8. The method (300) of claim 4, wherein first two-dimensional geometric figures (415) are detected (330) and then a three-dimensional figure (415) is detected (335) based on detected two-dimensional figures (415).

9. The method (300) of claim 4, wherein detected three-dimensional figure (415) are provided with surfaces (420).

10. A computer program product with program code means for performing the method (300) of claim 4 when it runs on an execution device (115, 120) or is stored on a computer-readable medium.
